(19) United States
(12) Patent Application Publication
(10) Pub. No.: US 2026/0367372 A1
(43) Pub. Date: Nov. 19, 2026

(54) POP-OUT WIDE-ULTRAWIDE ZOOM CAMERA LENSES

(71) Applicant: Corephotonics Ltd., Tel Aviv (IL)

(72) Inventors: Michael Scherer, Tel Aviv (IL); Gal Shabtay, Tel Aviv (IL); Michael Dror, Tel Aviv (IL); Ephraim Goldenberg, Tel Aviv (IL)

(21) Appl. No.: 19/112,469

(22) PCT Filed: Sep. 21, 2023
(86) PCT No.: PCT/IB2023/059355

§ 371 Date: Mar. 17, 2025

Related U.S. Application Data
(60) Provisional application No. 63/408,952, filed on Sep. 22, 2022.

(51) Int. Cl. G02B 15/22; H04N 23/55; H04N 23/667

(52) U.S. Cl. CPC G02B 15/22; H04N 23/55; H04N 23/667

(57) ABSTRACT

Lens systems for a compact pop-out camera, comprising an image sensor having a sensor diagonal (SD) and a zoom lens having N lens elements L1-LN arranged along a lens optical axis (OA). The lens elements may be divided into two lens groups G1 and G2 or three lens groups G1, G2 and G3. In some examples with two lens groups, N=1Oandazoom lens may have a Wide pop-outlens state with a Wide field-of-viewFOV_{W}=70-95 degrees, a Wide total track length TTL_{W}<30 mm, an Ultrawide (UW) pop-out lens state with an UW field-of-view FOVuw=100-140 degrees, an UW total track length TTLuw<30 mm, and a collapsed lens state with a collapsed total track length c-TTL<22.5 mm, wherein 7.5 mm<SD<30 mm, and wherein c-TTL/SD<1.3. In some example with three lens groups, N=11 and a zoom lens may have a Wide pop-out lens state with a FOV_{W}=70-95 degrees, a Wide total track length TTL_{W}<32 mm, a Tele (T) pop-out lens state with a FOVT=20-60 degrees, a T total track length TTLT<32 mm, and a collapsed lens state with a c-TTL<20 mm, wherein 7.5 mm<SD<30 mm, and wherein c-TTL/SD<1.3

### CROSS REFERENCE TO RELATED APPLICATIONS

This is a 371 application from international patent application PCT/IB2023/059355 filed Sep. 21, 2023, which claims the benefit of priority from U.S. Provisional patent application No. 63/408,952 filed Sep. 22, 2022, which is incorporated herein by reference in its entirety.

### FIELD

The present disclosure relates in general to digital cameras, and more particularly to digital cameras with pop-out mechanisms and zoom lenses.

### DEFINITIONS

In this application and for optical and other properties mentioned throughout the description and figures, the following symbols and abbreviations are used, all for terms known in the art:

Total track length (TTL): the maximal distance, measured along an axis parallel to the optical axis of a lens, between a point of the front surface S1 of a first lens element L1 and an image sensor, when the system is focused to an infinity object distance.

Back focal length (BFL): the minimal distance, measured along an axis parallel to the optical axis of a lens, between a point of the rear surface S2N of the last lens element LN and an image sensor, when the system is focused to an infinity object distance.

Effective focal length (EFL): in a lens (assembly of lens elements L1 to LN), the distance between a rear principal point P′ and a rear focal point F′ of the lens.

f-number (f/#): the ratio of the EFL to an entrance pupil diameter (EP).

“35 mm equivalent focal length” (35 eq.FL): indicates a (diagonal) field of view (FOV) of a camera.

### BACKGROUND

Multi-aperture digital cameras (or multi-cameras) are standard in today's mobile electronic devices (or in short “mobile devices”, e.g. smartphones, tablets, laptops, headsets etc.). In general, a multi-camera includes a Wide camera that acts as the mobile device's main (or “primary”) camera, an Ultrawide (UW) camera and a Tele (T) camera. The Main (or Wide) camera has a Wide camera sensor and a Wide camera field-of-view (FOV_{W}) of about 70-95 degrees (about 20 mm-30 mm 35 eq.FL), the UW camera has as a UW camera sensor and a UW camera field-of-view (FOVuw>FOV_{W}) of about 100-140 degrees (about 9 mm-18 mm 35 eq.FL), and the T camera has as a T camera sensor and a T camera field-of-view (FOVT<FOV_{W}) of about 20-60 degrees (about 35 mm-125 mm 35 eq.FL).

In the pursuit of achieving ever higher image quality (IQ), ever larger image sensors are incorporated in mobile devices. Such large image sensors may have an optical format equal to or larger than 1/1.5″, i.e. they have a full sensor diagonal (“SD”) of SD 2′: 10 mm, e.g. 1″ (SD=16 mm) or 4/3″ (SD=21 mm). Pop-out cameras described for example in co-owned international patent application PCT/IB2020/058697, which is incorporated herein in its entirety, allow the incorporation of large image sensors while supporting a slim thickness of a mobile device that includes the pop-out camera.

FIG. 1A illustrates schematically a mobile device 100 including a known pop-out camera 110 in a first state (“collapsed state”) when the camera is not in use (or inactive). In the collapsed state, pop-out camera 110 has a first TTL (“collapsed TTL” or “c-TTL”), as marked. The c-TTL is compatible with the height dimensions of modem mobile devices, i.e. in the collapsed state, pop-out camera 110 does not exceed a height (or thickness) of mobile device 100. The height of mobile device 100 may include an elevated area of mobile device 100 (“camera bump”) where a multi-camera is included.

FIG. 1B illustrates schematically mobile device 100 including pop-out camera 110 in a second state (“pop-out state”) when the pop-out camera is active. In general, only in the pop-outstate the pop-out camera is operational as a camera. In the pop-outstate, pop-out camera 110 has a second TTL (“TTL”) as marked. TTL>c-TTL, so that pop-out camera 110 exceeds a height of mobile device 100. In other words, in the pop-out statepop-outcamera 110 protrudes (or “pops out”) from mobile device 100. Typically, a mobile device has a thickness (“T”) of about T=5 mm-20 mm. A pop-out camera may protrude from a mobile device 100 by about 1 mm-15 mm.

However, the abovementioned trend of incorporating ever larger image sensors is pursued mainly for the Main camera, not for the UW camera and the T camera respectively. This means that a difference in terms of sensor area between a Main camera sensor and a UW camera sensor and T camera sensor respectively is increasing, going along with an increase in the gap (or difference) between a Main camera's IQ and a UW camera's and a T camera's IQ respectively, what is undesired.

It would be beneficial to have a pop-out camera including a large image sensor and a zoom lens, wherein the zoom lens allows both the Main camera and the UW camera or the Main camera and the Tele camera to use a single large image sensor.

### SUMMARY

In various exemplary embodiments, there is provided a lens system for a compact pop-out camera, comprising: an image sensor having a full sensor diagonal SD; and a zoom lens having N lens elements L1-LN starting with L1 from an object side toward an image side and arranged along a lens optical axis, the lens elements divided into two lens groups G1 and G2, wherein the zoomlens has a f/#and a Wide pop-out lens state with a Wide field-of-view FOV_{W}=70-95 degrees, a Wide total track length TTL_{W}<30 mm, a UW pop-out lens state with an UW field-of-view
FOVuw=100-140 degrees, an UW total track length TTLuw<30 mm, and a collapsed lens state with a collapsed total track length c-TTL<22.5 mm, wherein 7.5 mm<SD<30 mm, and wherein-TTL/SD<1.3.

In some examples, SD=15 mm-17 mm.

In some examples, SD=11 mm-13 mm, TTL_{W}::;21 mm, TTLuw::;22 mm, and c-TTL: S 16 mm.

In some examples, SD=9 mm-11 mm, TTL_{W}::;17.5 mm, TTLuw<20 mm, and c-TTL::; 13.5 mm.

In some examples, c-TTL<20 mm. In some examples, c-TTL/SD<1.25.

In some examples, FOV_{W}=75-85 degrees.

In some examples, FOVuw=115-125 degrees.

In some examples, the Wide pop-out lens state has a Wide back focal length BFL_{W}, the UW pop-out lens state has a UW back focal length BFLuw, and BFL_{W}>BFLuw.

In some examples, the Wide pop-out lens state has a gap dw between G1 and G2, the UW pop-out lens state has a UW having a gap duw between G1 and G2, and dw<duw.

In some examples, TTLuw<TTL_{W}. In some examples, TIL_{W}=TTLuw±20%. In some examples, TIL_{W}=TTLuw #10%.

In some examples, c-TTL/TTL_{W}<0.85. In some examples, c-TTL/TTL_{W}<0.8.

In some examples, fl #<4.0. In some examples, fl #<3.5. In some examples, f/#<3.0. In some examples, fl #<2.5.

In some examples, the fl #is identical in the Wide pop-out lens state and in the UW pop-out lens state.

In some examples, the lens elements are made of plastic.

In some examples, the lens system is included in a pop-out camera that has an actuator, wherein the actuator is operational to move G1 and G2 relative to each other and relative to the image sensor for switching the pop-out camera between the Wide pop-out lens state, the UW pop-outlens state and the collapsed state. In some examples, the actuator is operational to switch the pop-out camera between the Wide pop-out lens state and the UW pop-out lens state in a continuous manner. In some examples, the actuator is operational to switch the pop-out camera between the Wide pop-out lens state and the UW pop-out lens state in a discrete manner.

In various exemplary embodiments, there is provided a lens system for a pop-out camera, comprising: an image sensor having a full sensor diagonal SD; and a zoomlens that comprises N lens elements L1-LN arranged starting with L1 from an object side toward an image side along a lens optical axis, the lens elements divided into three lens groups G1, G2 and G3, the zoom lens has: a Wide pop-out lens state with a Wide field-of-view FOV_{W}=70-95 degrees, a Wide total track length TTL_{W}<32 mm, a Tele (T) pop-out lens state with a T field-of-view FOVT=20-60 degrees, a T total track length TILT<32 mm, and a collapsed lens state with a collapsed total track length c-TTL<20 mm, 7.5 mm<SD<30 mm, and c-TTL/SD<1.3.

In some examples of such a lens system, N=11.

In some examples, SD=13 mm-15 mm. In some examples, SD=11 mm-13 mm, TTL_{W}S 27.5 mm, TTLT S 28 mm, and c-TTL S 17 mm. In some examples, SD=7 mm-9 mm, TTL_{W} S 18.5 mm, TTLT S 20 mm, and c-TTL S 12 mm.

In some examples, TTL_{W}=TILT±20%. In some examples, TTL_{W}=TTLT±10%.

In some examples, c-TTL/TTLT<0.8. In some examples, c-TTL/TTLT<0.7. In some examples, c-TTL/TTLT<0.65.

In some examples, TTLT>TTL_{W}.

In some examples, FOV_{W}=75-85 degrees.

In some examples, FOVT=40-50 degrees.

In some examples, the Wide pop-out lens state has a first gap dw, 1-2 between G1 and G2, the T pop-out lens state has a first gap dT,1-2, and dw,1-2<du-2.

In some examples, the Wide pop-out lens state has a second gap dw,2-3 between G2 and G3, the T pop-out lens state has a second gap dT,2-3, and dw,2-3>dT,2-3-In some examples, the Wide pop-out lens state has a gap dw between G1 and G2, the UW pop-out lens state has a UW having a gap duw between G1 and G2, and dw<duw.

In some examples, the zoom lens has a f/#Tin the T pop-out lens state, and f/#T<8.0. In some examples, the zoom lens has a f/#y in the T pop-out lens state, and f/#y<7.0.

In some examples, the zoomlens has a f/#W in the Wide pop-out lens state, and f/#W<4.0.

In some examples, the zoom lens has a f/#W in the Wide pop-out lens state, and f/#W<3.0. In some examples, the zoom lens has a f/#w in the Widepop-out lens state, and f/#W<2.5.

In some examples, the lens system is included in a pop-out camera that has an actuator, wherein the actuator is operational to move G1, G2 and G3 relative to each other and relative to the image sensor for switching the pop-out camera between the Wide pop-out lens state, the Tele pop-outlens state and the collapsed state. In some examples, the actuator is operational to switch the pop-out camera between the W pop-out lens state and the T pop-out lens state in a continuous manner. In some examples, the actuator is operational to switch the pop-out camera between the W pop-outlens state and the T pop-out lens state in a discrete manner.

In some examples, a pop-out camera as above or below is included in a mobile device. In some examples, the mobile device is a smartphone.

### BRIEF DESCRIPTION OF THE DRAWINGS

Non-limiting examples of examples disclosed herein are described below with reference to figures attached here to that are listed following this paragraph. Identical structures, elements or parts that appear in more than one figure are generally labeled with a same numeral in all the figures in which they appear. If identical elements are shown but numbered in only one figure, it is assumed that they have the same number in all figures in which they appear. The drawings and descriptionsaremeanttoilluminateandclarifyexamplesdisclosedhereinandshouldnotbe considered limiting in any way. In the drawings:

FIG. 1A shows schematically an example of a known mobile device including a pop-out camera in a collapsed state in an isometric view;

FIG. 1B shows schematically an example of a known mobile device including a pop-out camera in a pop-out or active state in an isometric view;

FIG. 2A shows schematically a pop-out optical lens system disclosed herein in a first or Wide camera pop-out state;

FIG. 2B shows the pop-out system of FIG. 2A in a second or UW camera pop-out state;

FIG. 2C shows the pop-out system of FIGS. 2A-B in a collapsed state;

FIG. 3A shows schematically a pop-out optical lens system disclosed herein in a first or Wide camera pop-out state;

FIG. 3B shows the pop-out system of FIG. 3A in a second or Tele camera pop-out state;

FIG. 3C shows the pop-out system of FIGS. 3A-B in a collapsed state;

FIG. 4A shows an example of a pop-out optical lens system disclosed herein in a first or Wide camera pop-out state;

FIG. 4B shows the pop-out system of FIG. 4A in a second or UW camera pop-out state;

FIG. 4C shows the pop-out system of FIGS. 4A-B in a collapsed state.

FIG. 5A shows an example of a pop-out optical lens system disclosed herein in a first or Wide camera pop-out state;

FIG. 5B shows the pop-out system of FIG. 5A in a second or Tele camera pop-out state;

FIG. 5C shows the pop-out system of FIGS. 5A-B in a collapsed state.

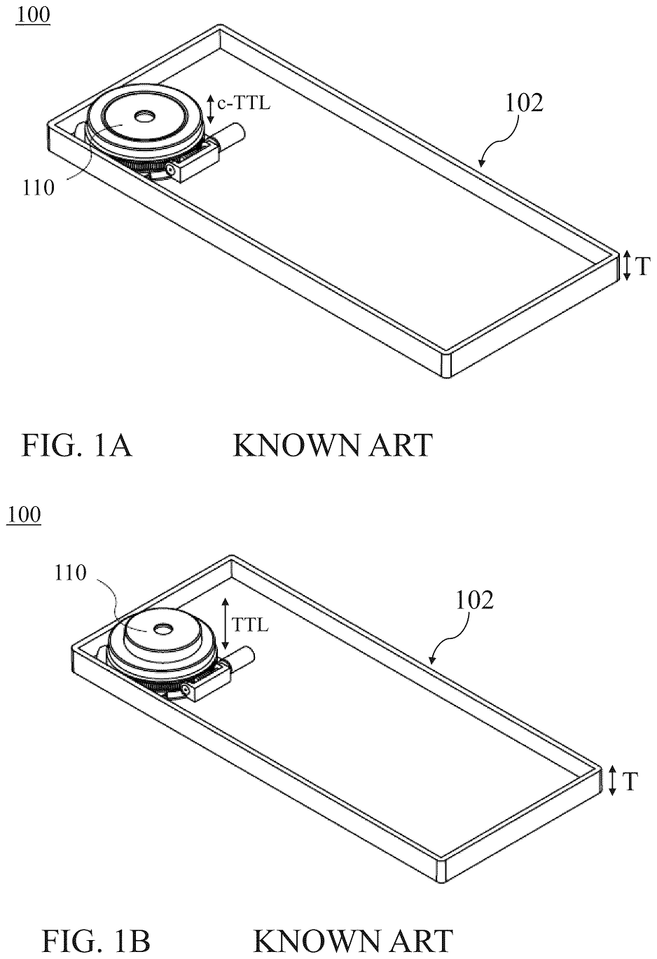

### DETAILED DESCRIPTION

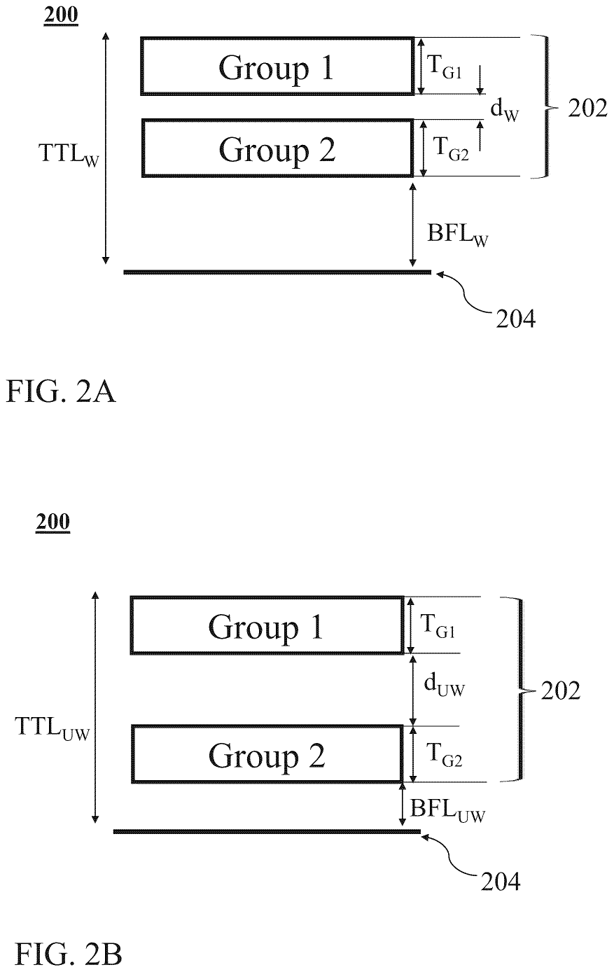

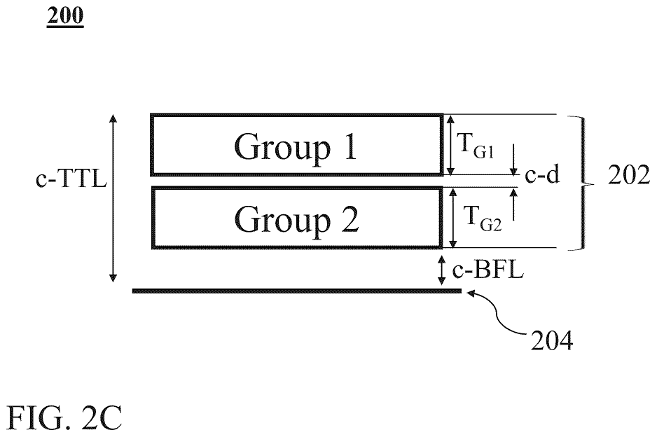

FIG. 2A shows schematically an example of a “two-group” (or “2G”) pop-out optical lens system as disclosed herein that comprises a pop-out lens 202, an image sensor 204 and numbered 200. Pop-out lens 202 is a zoomlens which is divided into two lens groups separated by a gap (or distance “d”), a first, object-sided lens group (“Group 1” or “G1”) and a second, sensor-sided lens group (“Group 2” or “G2”). The thickness of G1 and G2 is indicated by T_{G1} and Tm respectively. FIG. 2A shows pop-out optical lens system 200 in a first (or “Wide” or “W”) pop-out (or extended)
state. FOV_{W} may be 70-95 degrees. In the pop-out state, this and all other embodiments disclosed herein have a TTL_{W}, a BFL_{W} and a gap dw between G1 and G2.

FIG. 2B shows 2G pop-out optical lens system 200 in a second (or “UW”) pop-out state. In the second or UW pop-out state, pop-out optical lens system 200 images FOVuw onto image sensor 204. FOVuw maybe 100-140 degrees. In the UW pop-outstate, this and all other embodiments disclosed here in have a TTLuw, a BFLuw and a gap duw between G1 and G2, wherein BFLuw<BFL_{W} and duw>dw. In some examples TTLuw=TTL_{W}, in other examples TTLuw>TTL_{W}, and in yet other examples TTLuw<TTL_{W}. TTLuw and TTL_{W} may both be in the range between 5 mm-30 mm. In some examples, pop-out optical lens system 200 maybe operational to continuously switch between the W pop-out state and the UW pop-out state. I.e., pop-out optical lens system 200 is operational as camera to capture crisp (or “sharp”) images in the W pop-out state, in the UW pop-outstate and in each intermediate pop-outstate between the

W pop-out state and the UW pop-out state. In other examples, pop-out optical lens system 200 may be operational to discretely switch between the W pop-out state and the UW pop-out state. I.e., pop-out optical lens system 200 is operational as camera to capture crisp images only in the W pop-out state and in the UW pop-outstate.

FIG. 2C shows 2G pop-out optical lens system 200 in a collapsed state. Gap dis collapsed toa collapsed gap (marked “c-d”) and BFL is collapsed to a collapsed BFL (marked “c-BFL”), i.e. a distance between G1 and G2 is reduced and a distance between G2 and image sensor 204 is reduced, resulting in a c-TTL that fulfills c-TTL<TTL_{W} and c-TTL<TTLuw. In this and all other embodiments disclosed herein, c-d maybe in the range 0.01 mm-2.5 mm, c-BFL may be in the range may be in the range 0.01 mm-2.5 mm, and c-TTL may be in the range between 5 mm-25 mm. No other distances in pop-out optical lens system 200 change, e.g. distances between lens elements included in G1 and G2 respectively do not change. In this and all other embodiments disclosed herein, the c-TTL is compatible with the height dimensions of modem mobile devices (e.g. smartphones), i.e. in the collapsed state a pop-out camera including 2G pop-out optical lens system 200 does not exceed a height (or thickness) of a modem mobile device. To clarify, all optical lens systems disclosed herein may beneficially be included or incorporated in mobile devices such as smartphones or tablets etc.

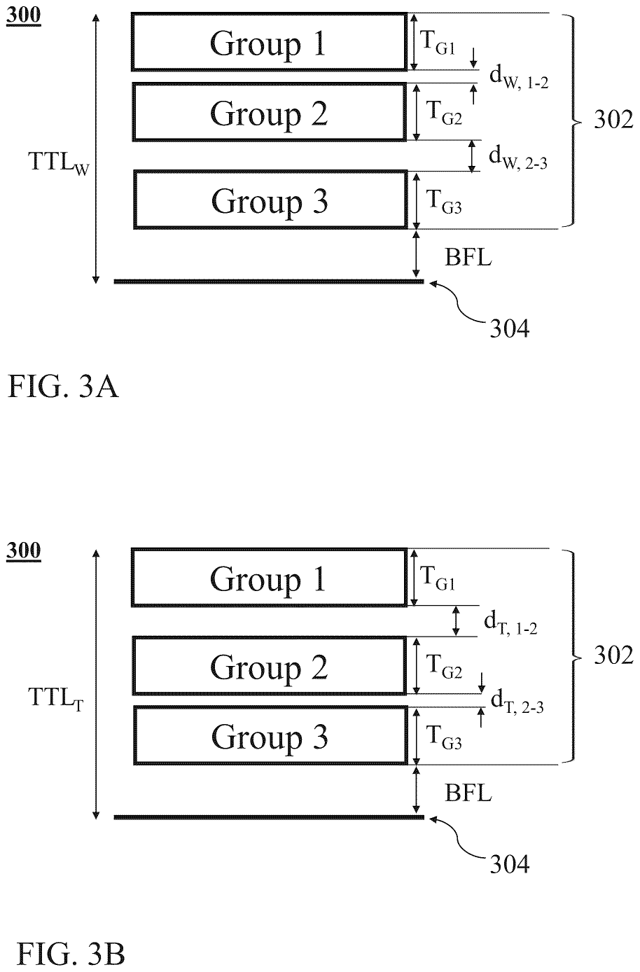

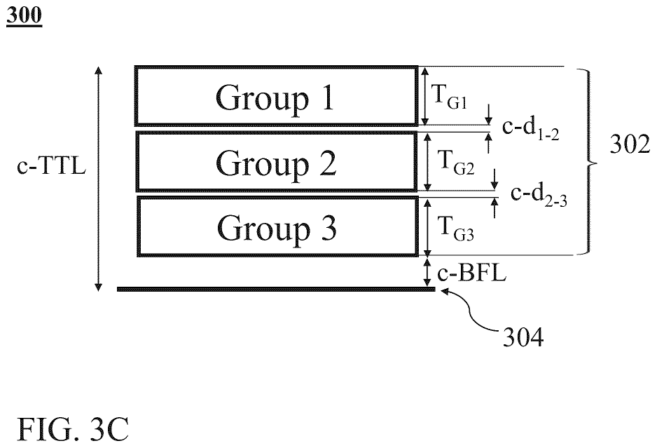

FIG. 3A shows schematically an example of a “three-group” (or “3G”) pop-out optical lens system as disclosed herein that comprises a pop-out lens 302, an image sensor 304 and numbered 300. Pop-out lens 302 is a zoom lens which is divided into three lens groups (“Group 1” or “G 1”, “Group 2” or “G2” and “Group 3” or “G3”). Distances between lens elements included in G1, G2 and G3 respectively do not change. The thickness of G1, G2 and G3 is indicated by T01, T02 and Tm respectively. FIG. 3A shows pop-out optical lens system 300 in a first (or “Wide” or “W”) pop-out state. FOV_{W} may be 70-95 degrees. In the W pop-out state, G1 and G2 are separated from each other by a first gap (“dw. 1-2”) and G2 and G3 are separated from each other by a second gap (“dw, 2-3”). In the pop-out state, this and all other embodiments disclosed herein have a TTL_{W}.

FIG. 3B shows 3G pop-out optical lens system 300 in a second (or “Tele” or “T”) pop-out state. In the second or T pop-outstate, pop-out optical lens system 300 images FOV_{T} onto image sensor 304. In this and all other embodiments disclosed herein, FOVr may be 20-60 degrees. In the T pop-out state, this and all other embodiments disclosed herein have a TTLr>TTL_{W}, a first gap dr, 1-2 between G1 and G2 and a second gap dr, 2-3 between G2 and G3, wherein dr,1-2>dw,1-2 and dr, 2-3<dw, 2-3. A BFL does not change when switching between a W pop-out state and a T pop-outstate. TTLr and TTL_{W} may both be in the range between 5 mm-35 mm.

In some examples, pop-out optical lens system 300 may be operational to continuously switch between the W pop-outstate and the T pop-out state. In other examples, pop-out optical lens system 300 may be operational to discretely switch between the W pop-out state and the T pop-out state.

FIG. 3C shows 3G pop-out optical lens system 300 in a collapsed state. The first gap and the second gap are collapsed first toa gap (marked “c-d1-2” and “c-d2-3” respectively, and BFL is collapsed to a collapsed BFL (marked “c-BFL”), i.e. distances between G1 and G2, between G2 and G3 as well as a distance between G3 and image sensor 304 are reduced, resulting in a c-TTL that fulfill sc-TTL<TTL_{W} and c-TTL<TTLr. In this and all other embodiments disclosed herein, both c-d1-2 and c-d2-3 may be in the range 0.01 mm-2.5 mm, c-BFL may be in the range 0.01 mm-2.5 mm, and c-TTL may be in the range between 5 mm-25 mm. No other distances in pop-out optical lens system 300 change, e.g. distances between lens elements included in G1, G2 and G3 respectively do not change. In this and all other embodiments disclosed herein, the c-TTL is compatible with the height dimensions of modem mobile devices (e.g. smartphones). To clarify, all optical lens systems disclosed herein may beneficially be included or incorporated in mobile devices such as smartphones or tablets etc.

A pop-out camera including 2G pop-out optical lens system 200 or 3G pop-out optical lens system 300 includes an actuator for switching the pop-out camera between a respective first pop-out state, a second pop-out state and the collapsed state. Such actuators are described for example in co-owned international patent application PCT/IB2020/058697, which is incorporated herein in its entirety, in co-owned international patent application PCT/IB2022/056646, which is incorporated herein in its entirety, and in co-owned international patent application PCT/IB2023/054411, which is incorporated herein in its entirety.

A pop-out camera including 2G pop-out optical lens system 200 or 3G pop-out optical lens system 300 may include a seal to prevent particles and fluids from entering the pop-out camera and a mobile device including the pop-out camera, so that IP68 class ranking may be supported.

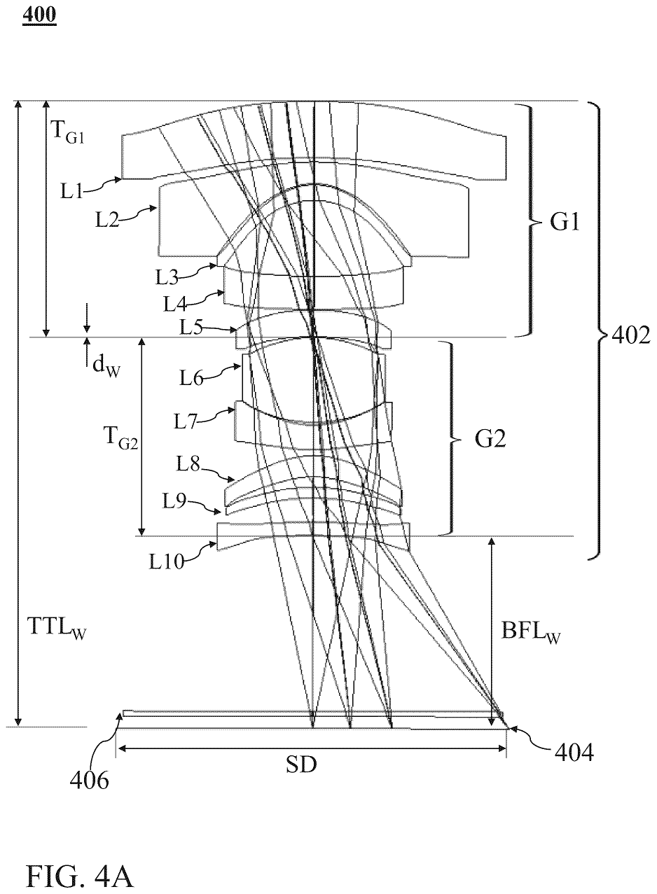

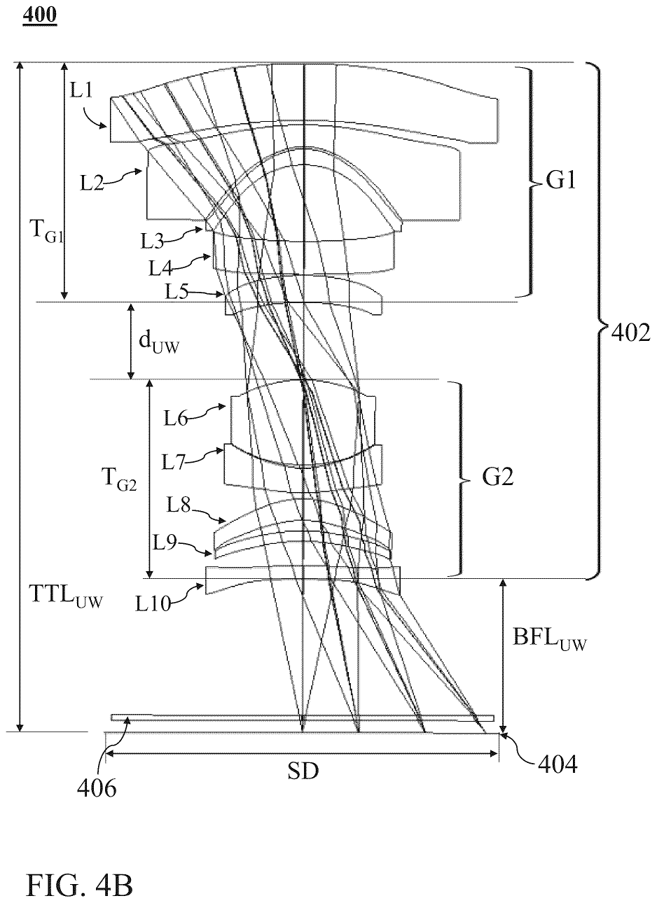

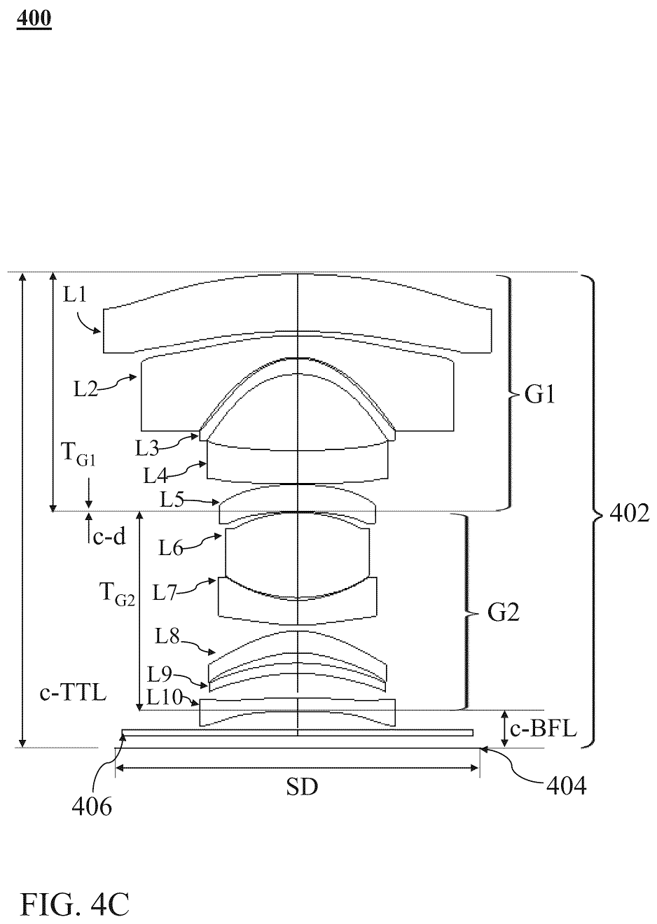

FIG. 4A shows an example of a 2G pop-out optical lens system disclosed herein and numbered 400. Pop-out optical lens system 400 is shown in a first (or “W”) pop-out (or extended) state. In the first or Wide pop-out state, pop-out optical lens system 400 has a FOV_{W}=80 degrees (26 mm 35 eq.FL). In other embodiments, FOV_{W} may be in the range of 70-95 degrees. Lens system 400 comprises a pop-out zoom lens 402 divided into two lens groups G1 and G2, an image sensor 404 and, optionally, an optical element 406. Optical element 406 may be for example infra-red (IR) filter, and/or a glass image sensor dust cover. Image sensor 404 has a full sensor diagonal (SD) of 16 mm. In other examples, 7.5 mm::;SD::;25 mm. G1 includes five lens elements (L1-LS) and G2 includes five lens elements (L6-L10). Optical rays pass through lens 402 and form an image on image sensor 404. FIGS. 4A-B shows four fields with 3 rays for each: the upper marginal-ray, the lower marginal-ray and the chief-ray. All further figures show these 3 rays as well. In the Widepop-outstate, pop-out optical lens system 400 has a TTL_{W}=25.2 mm, a BFL_{W}=7.65 mm and a gap dw=0.03 mm between G1 and G2, see Table 2. A ratio between BFL_{W} and TTL_{W} fulfills BFL_{W}/TTL_{W}=0.3.

FIG. 4B shows 2G pop-out optical lens system 400 in a second (or “UW”) pop-out state. In the second or UW pop-out state, pop-out optical lens system 400 has a FOV_{W}=118 degrees (13 mm 35 eq.FL). In other embodiments, FOVuw may be in the range of 100-140 degrees. In the UW pop-out state, pop-out optical lens system 400 has a TTLuw=26.6 mm, a BFLuw=5.98 mm and a gap duw=3.09 mm between G1 and G2, see Table 2. A ratio between duw and TTLuw fulfills duw/TTLuw=0.12. A f/#in the W pop-out state is identical to a f/#in the UW pop-out state.

FIG. 4C shows 2G pop-out optical lens system 400 in a collapsed state. In the collapsed state, pop-out optical lens system 400 has a c-TTL=19.6 mm, a c-BFL=1.4 mm and a c-d=0.02 mm. A ratio of c-TTL/SD=1.225. A ratio of c-TTL/TTL_{W}=0.78.

Lens 402 includes a plurality of N lens elements Li (wherein “i” is an integer between 1 and 5 N and wherein N may be for example between 5 and 10). L1 is the lens element closest to the object side and LN is the lens element closest to the image side, i.e. the side where the image sensor is located. This order holds for all lenses and lens elements disclosed herein. Each lens element Li comprises a respective front surface S2i-1 (the index “2i-1” being the number of the front surface) and a respective rear surface S2i (the index “2i” being the number of the rear surface). This numbering convention is used throughout the description. Alternatively, as done throughout this description, lens surfaces are marked as “Sk”, with k running from 1 to 2 N. The front surface and the rear surface may be in some cases aspherical. This is however not limiting.

As used herein the term “front surface” of each lens element refers to the surface of a lens element located closer to the entrance of the camera (camera object side) and the term “rear surface” refers to the surface of a lens element located closer to the image sensor (camera image side).

Detailed optical data and surface data for pop-out lens 402 are given in Tables 1-3. Table 1 provides surface types. Table 2 provides values that change between the Widepop-outstate (FIG. 4A) and the UW pop-out state (FIG. 4B). In Table 2, “Ti” indicates a thickness of surface i. Tl ◯ provides the values for a distance d between G1 and G2. EFL, TTL and BFL are given in mm, FOV is given in degrees. Table 3 provides aspheric coefficients. The surface types are:
a) Plano: flat surfaces, no curvature.
b) Q type 1 (QT1) surface sag formula:

$$z ( r ) = \begin{matrix}{cr}^{2} \\ ‐ ‐ ‐ ‐ ‐ ‐ ‐ ‐ ‐ ‐ ‐ ‐ ‐ ‐ ; \text{::} === == \\ 1 + \underline{- J 1} - ( 1 + k ) {c}^{2} {r}^{2}\end{matrix} + DcanCu ) DeonCu ) = u 4 \\ I := OAn Q oncuz ) u = \begin{matrix}r \\ -- \\ rnorm\end{matrix} , x = {u}^{2} {Qg}^{0} n ( x ) = 1 \\ Q : {f}^{0} n = - ( 5 - 6 x ) \\ {Qf}^{0} n = 15 - 14 x ( 3 - 2 x ) \\ Q [ {f}_{n}^{0} = - \{ 35 - 12 x [ 14 - x ( 21 - 10 x ) ] \} \\ Qgon = 70 - 3 x \{ 168 - 5 x [ 84 - 11 x ( 8 - 3 x ) ] \} \\ Qgon = - [ 126 - x ( 1 \; 260 - 11 x \{ 420 - x [ 720 - 13 x ( 45 - 14 x ) ] \} ) ] \qquad ( Eq . 1 )$$

c) Even Asphere (ASP) surface sag formula:

$$z ( r ) = \begin{matrix}{cr}^{2} \\ \text{\_.} \cdot -- -- -- \\ 1 + \underline{J 1} - 22\end{matrix} + a 1 {r}^{2} + {a}_{2} {r}^{4} + a 3 {r}^{6} + {a}_{4} {r}^{8} + a 5 {r}^{10} + a 6 {r}^{12} + a 7 r 14 + asr 16 \qquad ( Eq . 2 )$$

where {z, r} are the standard cylindrical polar coordinates, c is the paraxial curvature of the surface, k is the conic parameter, fnorm is generally one half of the surface's clear aperture (CA), and An are the aspheric coefficients shown in lens data tables. The Z axis is positive towards the image side. Values for CA are given as a clear aperture radius, i.e. D/2. The reference wavelength is 555.0 nm.

Units are in mm except for refractive index (“Index”) and Abbe #. Each lens element Li has a respective focal length fi, given in Table 1. The FOV is given as half POV (HFOV). The definitions for surface types, Z axis, CA values, reference wavelength, units, focal length and HFOV are valid for all following Tables.

TABLE 1
Lens system 400

| Surface | | | Curvature | | ApertureRadius | | | Abbe | |
|---|---|---|---|---|---|---|---|---|---|
| # | Comment | Type | Radius | Thickness | (D/2) | Material | Index | # | FocalLength |
| 1 | Lens 1 | Evenasp. | 22.381 | 2.287 | 7.7 | Plastic | 1.680 | 18.2 | 9926.18 |
| 2 | | | 21.521 | 0.172 | 6.6 | | | | |
| 3 | Leas 2 | Evenasp. | 12.281 | 0.874 | 6.2 | Plastic | 1.567 | 37.4 | −5.78 |
| 4 | | | 2.532 | 0.090 | 3.9 | | | | |
| 5 | Lens 3 | Evenasp. | 2.416 | 0.625 | 3.9 | Plastic | 1.635 | 24.0 | 12.71 |
| 6 | | | 3.090 | 3.065 | 3.6 | | | | |
| 7 | Lens 4 | Evenasp. | −20.781 | 1.332 | 3.6 | Plastic | 1.535 | 56.0 | −119.89 |
| 8 | | | −31.390 | 0.030 | 3.5 | | | | |
| 9 | Lens 5 | Evenasp. | 9.501 | 1.080 | 3.1 | Plastic | 1.680 | 18.2 | 69.25 |
| 10 | | | 11.322 | See | 2.8 | | | | |
| | | | | Table2 | | | | | |
| 11 | Lens 6 | Evenasp. | 5.189 | 3.414 | 2.6 | Plastic | 1.544 | 56.0 | 5.44 |
| 12 | | | −5.334 | 0.120 | 2.9 | | | | |
| 13 | Lens 7 | Evenasp. | −3.241 | 0.995 | 2.9 | Plastic | 1.671 | 19.2 | −12.00 |
| 14 | | | −6.060 | 0.222 | 3.1 | | | | |
| 15 | Lens8 | Evenasp. | 3.331 | 0.864 | 3.6 | Plastic | 1.535 | 55.7 | 27.89 |
| 16 | | | 3.897 | 0.432 | 3.5 | | | | |
| 17 | Lens 9 | Evenasp. | 8.664 | 0.411 | 3.5 | Plastic | 1.680 | 18.2 | −146.63 |
| 18 | | | 7.824 | 0.980 | 3.5 | | | | |
| 19 | Lens 10 | Evenasp. | 34.267 | 0.544 | 3.6 | Plastic | 1.535 | 56.0 | 91.13 |
| 20 | | | ll4.022 | See | 3.9 | | | | |
| | | | | Table 2 | | | | | |
| 21 | Filter | Plano | Infinity | 0.21 | — | Glass | 1.52 | 64.2 | |
| 22 | | | Infinity | 0.35 | — | | | | |
| 23 | Image | Plano | Infinity | — | — | | | | |

TABLE 2

| | 1″ image sensor | | | | | | | | |
|---|---|---|---|---|---|---|---|---|---|
| | EFL | FOV | | SD | TTL | c-TTL | BFL | TIO | T20 |
| Lens state | (mm) | (deg) | fl# | (mm) | (mm) | (mm) | (mm) | (mm) | (mm) |

| | | | | | | | | |
|---|---|---|---|---|---|---|---|---|
| Wide | 8.66 | 80 | 2.45 | 25.2 | 19.6 | 7.65 | 0.03 | 7.09 |
| Ultrawide | 6.22 | ll8 | 2.45 | 26.6 | | 5.98 | 3.09 | 5.42 |

TABLE 3

| Surface | | | | | | | |
|---|---|---|---|---|---|---|---|
| # | NormRadius | al | a2 | a3 | a4 | a5 | a6 |
| 2 | 4.077 | 0 | 2.00E−04 | −2.17E−06 | −7.44E−08 | 1.03E−09 | −7.13E−12 |
| 3 | 8.926 | 0 | −1.21E−04 | 4.11E−06 | −3.63E−07 | 2.29E−09 | 1.68E−ll |
| 4 | 2.582 | 0 | −4.88E−04 | −1.50E−05 | −1.09E−09 | 3.40E−09 | −2.73E−ll |
| 5 | −2.446 | 0 | 5.34E−03 | −9.55E−06 | −1.97E−06 | −1.56E−07 | −1.29E−09 |
| 6 | −2.330 | 0 | 8.30E−03 | −2.39E−04 | −4.10E−07 | −1.98E−07 | −3.56E−09 |
| 7 | −1.005 | 0 | 5.26E−03 | −4.0lE−05 | −8.82E−06 | 1.70E−07 | −1.60E−08 |
| 8 | 21.405 | 0 | 1.31E−03 | −6.46E−05 | −2.70E−06 | −2.28E−08 | 3.41E−09 |
| 9 | 40.488 | 0 | 1.95E−03 | −1.95E−04 | 2.57E−06 | 3.76E−08 | −3.13E−09 |
| 10 | −0.185 | 0 | 2.25E−03 | 5.09E−05 | 1.71E−06 | 2.5lE−07 | −7.55E−09 |
| 11 | −4.033 | 0 | 8.73E−04 | 2.58E−04 | −1.43E−05 | 1.46E−06 | −3.98E−09 |
| 12 | −1.080 | 0 | 1.76E−04 | 5.84E−05 | −3.18E−06 | 1.19E−08 | 1.36E−08 |
| 13 | −6.879 | 0 | −3.64E−03 | −1.lOE−04 | 5.66E−06 | 1.24E−07 | −1.04E−08 |
| 14 | −6.901 | 0 | −1.13E−03 | −2.54E−04 | −5.45E−07 | 5.41E−07 | 3.29E−09 |
| 15 | −19.397 | 0 | 3.48E−03 | −3.60E−04 | 1.14E−05 | 1.45E−07 | −2.97E−09 |
| 16 | −3.751 | 0 | 6.17E−04 | 2.24E−05 | −1.81E−06 | 3.38E−08 | 3.73E−09 |
| 17 | −6.026 | 0 | 1.92E−03 | −3.34E−04 | 1.94E−05 | 3.90E−07 | −1.lOE−09 |
| 18 | −1.028 | 0 | 2.71E−03 | −4.52E−04 | 1.96E−05 | 2.91E−07 | −1.15E−09 |
| 19 | 2.674 | 0 | −1.27E−03 | −1.53E−04 | 6.27E−06 | 2.66E−09 | 4.85E−09 |
| 20 | 26.938 | 0 | 1.lOE−03 | −2.48E−04 | 6.42E−06 | 8.41E−08 | −5.53E−09 |
| 21 | 28.017 | 0 | 5.35E−03 | −1.40E−04 | −4.49E−06 | −2.91E−08 | 5.35E−09 |

It is noted that an optical lens system such as pop-out optical lens system 400 can be linearly scaled, as known in the art. For example, using a smaller image sensor reduces a TTL and thus a height of a camera including the optical lens system. Specifically, Table 4 and Table 5 show values and dimensions of a camera including pop-out optical lens system 400 with a SD of 12 mm (Table 4) and 10 mm (Table 5) respectively. In other examples, pop-out optical lens system 400 may be scaled so that a SD in the range of 7.5 mm SSD S25 mm is achieved.

TABLE 4

| | 1/1.33″ image sensor | | | | | | |
|---|---|---|---|---|---|---|---|
| Lens state | EFL(mm) | FOV (deg) | fl# | SD(mm) | TTL(mm) | c-TTL(mm) | BFL(mm) |
| Wide | 6.51 | 80 | 2.45 | 12 | 18.95 | 14.74 | 5.75 |
| Ultrawide | 4.68 | 118 | 2.45 | 12 | 20.00 | | 4.50 |

TABLE 5
1/1.6″ image sensor

| Lens state | EFL(mm) | FOV (deg) | fl# | SD(mm) | TTL(mm) | c-TTL(mm) | BFL(mm) |
|---|---|---|---|---|---|---|---|
| Wide | 5.41 | 80 | 2.45 | 10 | 15.75 | 12.25 | 4.78 |
| Ultrawide | 3.89 | 118 | 2.45 | 10 | 16.63 | | 3.74 |

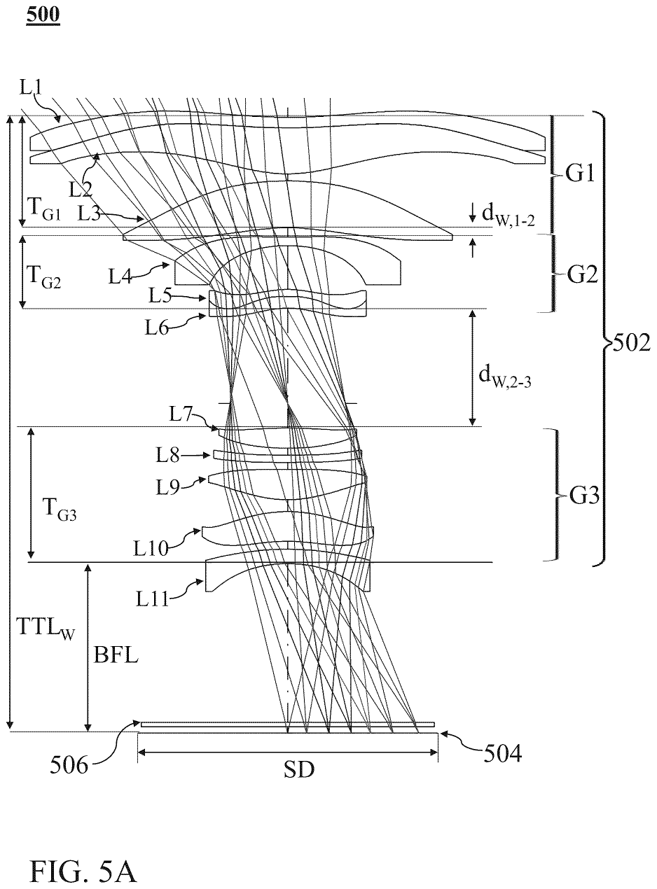

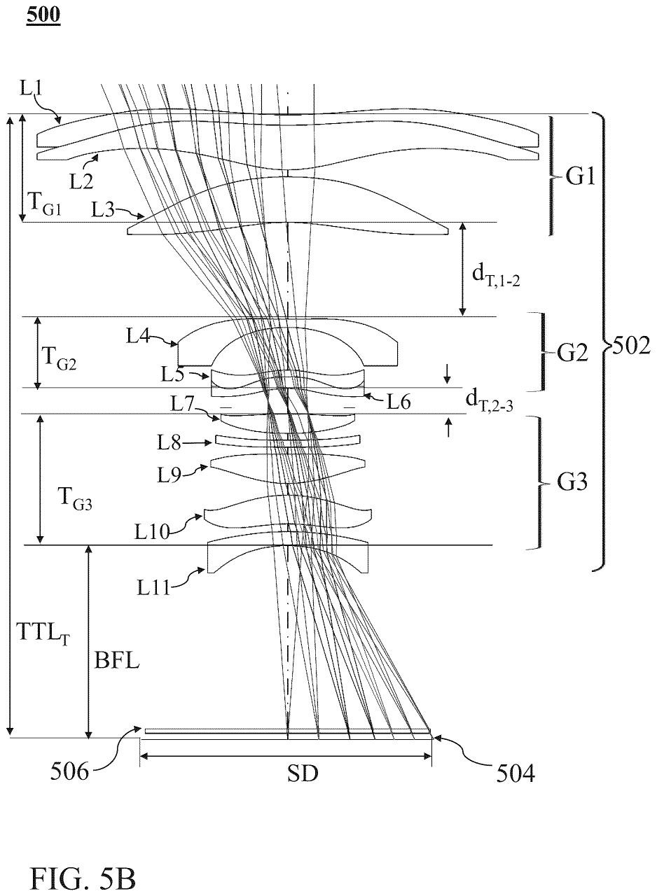

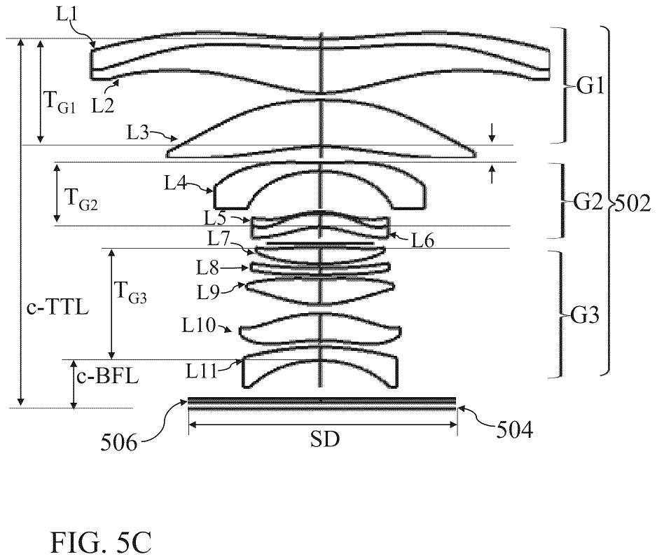

FIG. SA shows an example of a 3G pop-out optical lens system disclosed herein and numbered 500. Pop-out optical lens system500 is shown in a first (or “W”) pop-out (or extended) state. In the first or Wide pop-out state, pop-out optical lens system500 has a FOV_{W}=80 degrees (26 mm 35 eq.FL). In other embodiments, FOV_{W} may be in the range of 70-95 degrees. Lens system500 comprises a pop-out zoom lens 502 divided into three lens groups G1, G2 and G3, an image sensor 504 and, optionally, an optical element 506. Optical element 506 may be for example infra-red (IR) filter, and/or a glass image sensor dust cover. Image sensor 504 has a full sensor diagonal (SD) of 14 mm. In other examples, 7 mm;::;SD::;25 mm. Lens 502 includes a plurality of N=11 lens elements. G1 includes three lens elements (L1-LJ), G2 includes three lens elements
(1A-L6) and G3 includes five lens elements (L7-L11). TGJ=5.3 mm, Tm=3.2 mm and Tm=5.6 mm. Optical rays pass through lens502 and form an image on image sensor 504. FIGS. 5A-B shows seven fields with 3 rays foreach: the upper marginal-ray, the lower marginal-ray and the chief-ray. Detailed optical data and surface data for pop-out lens502 are given in Tables 6-8. Table 6 provides surface types. Table 7 provides values that change between the Wide pop-out state (FIG. 5A) and the T pop-out state (FIG. 5B). In Table 7, “Ti” indicates a thickness of surfacei.TS provides the values for a distance d1-2 between G1 and G2. T10+T11 provides the values for a distance d2-3 between G2 and G3. Table 8 provides a spheric coefficients.

In the W pop-outstate, pop-out optical lens system 500 has a TTL_{W}=28.6 mm, a first gap dw, 1-2=0.27 mm between G1 and G2 and a second gap dw, 2-3-6.29 mm between G2 and G3 as well as a BFL=7.34 mm, see Table 7. A ratio between dw, 2-3 and TTL_{W} fulfills dw, 2-3/TTL_{W}=0.22.

FIG. 5B shows 3G pop-out optical lens system 500 in a second (or Teleor “T”) pop-outstate. In the second or T pop-outstate, pop-out optical lens system500 has a FOVr=45 degrees (52 mm 35 eq.FL). In other embodiments, FOVr may be in the range of 20-60 degrees. In the T pop-out state, pop-out optical lens system500 has a TTLr=29.8 mm, a first gap dr, 1−2=4.87 mm between G1 and G2 and a second gap dr, 2−3=0.98 mm between G2 and G3. The BFL does not change between the W pop-out state and the Tpop-outstate. Values are given in Table 7. A ratio between dr,1-2 and TTLr fulfills dr, 1-2/TTLr=0.16. A ratio BFL/TTLr=0.25. A f/#in the W pop-out state (“f/#W”) differs from a f/#in the Tpop-out state (“f/#r”). In fact, an entrance pupil diameter (“EP”) of 3G pop-out optical lens system 500 is larger in the W pop-out state than in the T pop-out state (Table 7).

FIG. SC shows 3G pop-out optical lens system 500 in a collapsed state. In the collapsed state, pop-out optical lens system 500 has a c-TTL=17.8 mm, a c-BFL in the range of 0.01 mm-2.Smm, a first collapsed gap c-d1.2 between G1 and G2 in the range 0.01 mm-2.Smm and a second collapsed gap c-d2.3 between G2 and G3 in the range 0.01 mm-2.Smm. A ratio of c-TTL/SD=1.27. A ratio of c-TTL/TTLT=0.59.

TABLE 6
Lens system 500

| Sutface | | | Curvature | | | | | | Focal |
|---|---|---|---|---|---|---|---|---|---|
| # | Comment | Type | Radius | Thickness | ApertureRadius(D/2) | Material | Index | Abbe# | Length |
| 1 | Lens 1 | QFORB | −22.719 | 0.479 | 12.03 | Glass | 1.847 | 23.780 | −41.49 |
| | | type 1 | | | | | | | |
| 2 | Lens 2 | QFORB | −24.268 | 2.202 | 12.24 | Glass | 1.529 | 76.976 | 10.22 |
| | | type 1 | | | | | | | |
| 3 | | QFORB | −6.149 | 0.342 | 11.49 | | | | |
| | | type 1 | | | | | | | |
| 4 | Lens 3 | QFORB | 13.697 | 2.290 | 11.04 | Glass | 1.529 | 76.976 | −45.80 |
| | | type 1 | | | | | | | |
| 5 | | QFORB | 8.248 | SeeTable | 8.08 | | | | |
| | | type 1 | | 7 | | | | | |
| 6 | Lens 4 | QFORB | −30.214 | 0.427 | 7.86 | Glass | 1.691 | 54.762 | −7.40 |
| | | type 1 | | | | | | | |
| 7 | | QFORB | 6.210 | 2.001 | 5.38 | | | | |
| | | type 1 | | | | | | | |
| 8 | Lens 5 | QFORB | 3.598 | 0.101 | 3.67 | Glass | 1.788 | 47.490 | 4.40 |
| | | type 1 | | | | | | | |
| 9 | Lens 6 | QFORB | 8.288 | 0.651 | 3.52 | Glass | 1.847 | 23.780 | −4.20 |
| | | type 1 | | | | | | | |
| 10 | | QFORB | 3.468 | SeeTable | 3.44 | | | | |
| | | type 1 | | 7 | | | | | |
| 11 | STOP | | Infinity | SeeTable | 3.40 | | | | |
| | | | | 7 | | | | | |
| 12 | Lens 7 | QFORB | 19.078 | 0.836 | 2.51 | Glass | 1.529 | 76.976 | 13.79 |
| | | type 1 | | | | | | | |
| 13 | | QFORB | −11.666 | 0.200 | 2.98 | | | | |
| | | type 1 | | | | | | | |
| 14 | Lens 8 | QFORB | −84.670 | 0.331 | 3.06 | Glass | 1.847 | 23.780 | 199.88 |
| | | type 1 | | | | | | | |
| 15 | | QFORB | −56.677 | 0.198 | 3.22 | | | | |
| | | type 1 | | | | | | | |
| 16 | Lens 9 | QFORB | −47.562 | 1.275 | 3.30 | Glass | 1.529 | 76.976 | 11.55 |
| | | type 1 | | | | | | | |
| 17 | | QFORB | −5.473 | 0.450 | 3.51 | | | | |
| | | type 1 | | | | | | | |
| 18 | Lens 10 | | 6.609 | 1.314 | 3.56 | Glass | 1.501 | 56.409 | 68.82 |
| 19 | | | 7.625 | 0.335 | 3.85 | | | | |
| 20 | Lens 11 | | 12.226 | 0.665 | 3.93 | Glass | 1.805 | 25.432 | −15.01 |
| 21 | | QFORB | 5.951 | 6.848 | 3.79 | | | | |
| | | type 1 | | | | | | | |
| 21 | Filter | Plano | Infinity | 0.21 | — | Glass | 1.52 | 64.2 | |
| 22 | | | Infinity | 0.29 | — | | | | |
| 23 | Image | Plano | Infinity | — | — | | | | |

TABLE 7

| | | 1/1.12″ image sensor | | | | | | | | | |
|---|---|---|---|---|---|---|---|---|---|---|---|
| Lens | EFL | FOV | EP | | SD | TTL | c-TTL | BFL | TS | TIO | |
| state | (mm) | (deg) | (mm) | fl# | (mm) | (mm) | (mm) | (mm) | (mm) | (mm) | Tll(mm) |
| Wide | 8.3 | 80 | 3.9 | 2.14 | 14 | 28.6 | 17.8 | 7.34 | 0.27 | 4.92 | 1.37 |
| Tele | 16.7 | 45 | 2.5 | 6.8 | 14 | 29.8 | | | 4.87 | 0.8 | 0.18 |

TABLE 8

| Surface# | Norm Radius | al | a2 | a3 | a4 |
|---|---|---|---|---|---|
| 1 | 0.735 | 12.255 | 5.434E+00 | −7.031E−0l | 1.823E−0l |
| 2 | 0.016 | 11.692 | 5.077E+00 | −8.425E−0l | 1.074E−0l |
| 3 | −8.118 | 11.199 | 3.427E+00 | −4.490£−01 | 1.714£−01 |
| 4 | −1.790 | 8.147 | 9.204E−01 | −3.549£−01 | 9.956£−02 |
| 5 | −30.649 | 8.220 | −7.980E−0l | 1.032£−01 | 7.328£−03 |
| 6 | 26.952 | 5.443 | 2.272E+00 | −1.152£−01 | 6.685E−02 |
| 7 | 1.852 | 3.650 | 1.600E−0l | −5.626E−03 | −1.390E−02 |
| 8 | −2.278 | 3.539 | −1.285E+00 | 1.455E−0l | −6.391E−03 |
| 9 | −2.401 | 3.495 | 1.095E−0l | −4.073E−0l | 1.002E−0l |
| 10 | −2.061 | 3.428 | −9.719E−0l | 1.105£−01 | −8.772£−03 |
| 11 | 19.991 | 3.010 | −2.135E−0l | −1.681£−02 | −5.018£−03 |
| 12 | −2.691 | 3.091 | −1.357E−0l | −1.165£−02 | −9.519£−03 |
| 13 | 11.461 | 3.229 | −1.708E−0l | 2.805E−02 | −2.754E−03 |
| 14 | −17.371 | 3.311 | −1.112E−0l | 3.732E−03 | 1.982E−03 |
| 15 | 15.956 | 3.493 | 4.026E−0l | −3.891E−02 | 9.413E−03 |
| 16 | −10.075 | 3.525 | −8.507E−02 | 4.106E−02 | −2.338E−03 |
| 17 | −5.939 | 3.820 | −3.677E−02 | −1.012E−01 | −6.995E−03 |
| 18 | −19.903 | 3.887 | −7.482E−0l | −2.916E−02 | −6.761E−03 |
| 19 | 7.239 | 3.742 | −2.493E−0l | −5.654E−03 | −6.176E−03 |
| 20 | −1.305 | 3.446 | 3.321E−0l | −5.829E−03 | −3.241E−03 |
| 21 | 0.735 | 12.255 | 5.434E+00 | −7.031E−0l | 1.823E−0l |
| 22 | 0.016 | 11.692 | 5.077E+00 | −8.425E−0l | 1.074E−0l |
| 23 | −8.118 | 11.199 | 3.427E+00 | −4.490E−0l | 1.714E−0l |

It is noted that pop-out optical lens system 500 can be linearly scaled. Specifically, Table 9 and Table 10 show values and dimensions of a camera including pop-out optical lens system 500 with a SD of 12 mm (Table 9) and 8 mm (Table 10) respectively. In other examples, pop-out optical lens system 500 may be scaled so that a SD in the range of 5 mm::;;SD:::;25 mm is achieved.

TABLE 9
1/1.33″ image sensor

| Lens | EFL | FOV | | SD | TTL | c-TTL | EFL |
|---|---|---|---|---|---|---|---|
| state | (mm) | (deg) | fl# | (mm) | (mm) | (mm) | (mm) |
| Wide | 7.09 | 80 | 2.14 | 12 | 24.44 | 15.21 | 6.27 |
| Tele | 14.27 | 45 | 6.8 | 12 | 25.47 | | |

TABLE 10
½″ image sensor

| | EFL | FOV | | SD | TTL | c-TTL | EFL |
|---|---|---|---|---|---|---|---|
| Lensstate | (mm) | (deg) | fl# | (mm) | (mm) | (mm) | (mm) |
| Wide | 4.74 | 80 | 2.14 | 8 | 16.34 | 10.17 | 4.19 |
| Tele | 9.54 | 45 | 6.8 | 8 | 17.03 | | |

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

It is appreciated that certain features of the presently disclosed subject matter, which are, for clarity, described in the context of separate examples, may also be provided in combination in a single example. Conversely, various features of the presently disclosed subject matter, which are, for brevity, described in the context of a single example, may also be provided separately or in any suitable sub-combination.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

All patents and patent applications mentioned in this specification are herein incorporated in their entirety by reference into the specification, to the same extent as if each individual patent orpatentapplicationwasspecificallyandindividuallyindicatedtobeincorporatedhereinby reference. In addition, citation or identification of any reference in this application shall not be construed as an admission that such reference is available as prior art to the present disclosure.

1.-27. (canceled)

28. A lens system for a pop-out camera, comprising:
an image sensor having a full sensor diagonal SD; and
a zoom lens that comprises N lens elements L1-LN arranged starting with L1 from an object side toward an image side along a lens optical axis, the lens elements divided into three lens groups G1, G2 and G3, wherein the zoom lens has:
a Wide pop-out lens state with a Wide field-of-view FOV_{W}=70-95 degrees, a Wide total track length TTL_{W}<32 mm,
a Tele (T) pop-out lens state with a T field-of-view FOV_{T}=20-60 degrees, a T total track length TTL_{T}<32 mm, and
a collapsed lens state with a collapsed total track length c-TTL<20 mm, wherein 7.5 mm<SD<30 mm, and wherein c-TTL/SD<1.3.

29. The lens system of claim 28, wherein N=11.

30. The lens system of claim 28, wherein SD=13 mm-15 mm.

31. The lens system of claim 28, wherein SD=11 mm-13 mm, wherein TTL_{W}≤27.5 mm, wherein TTL_{T}≤28 mm, and wherein c-TTL≤17 mm.

32. The lens system of claim 28, wherein SD=7 mm-9 mm, wherein TTL_{W}≤18.5 mm, wherein TTL_{T}≤20 mm, and wherein c-TTL≤12 mm.

33. The lens system of claim 28, wherein TTL_{W}=TTL_{T}±20%.

34. The lens system of claim 28, wherein TTL_{W}=TTL_{T}±10%.

35. The lens system of claim 28, wherein c-TTL/TTL_{T}<0.8.

36. The lens system of claim 28, wherein c-TTL/TTL_{T}<0.7.

37. The lens system of claim 28, wherein c-TTL/TTL_{T}<0.65.

38. The lens system of claim 28, wherein TTL_{T}>TTL_{W}.

39. The lens system of claim 28, wherein FOV_{W}=75-85 degrees.

40. The lens system of claim 28, wherein FOV_{T}=40-50 degrees.

41. The lens system of claim 28, wherein the Wide pop-out lens state has a first gap d_{W,1-2} between G1 and G2, wherein the T pop-out lens state has a first gap d_{T,1-2}, and wherein d_{W,1-2}<d_{T,1-2}.

42. The lens system of claim 28, wherein the Wide pop-out lens state has a second gap d_{W,2-3} between G2 and G3, wherein the T pop-out lens state has a second gap d_{T,2-3}, and wherein d_{W,2-3}>d_{T,2-3}.

43. The lens system of claim 28, wherein the zoom lens has a f/#in the T pop-out lens state, and wherein f/#_{T}<8.0.

44. The lens system of claim 28, wherein the zoom lens has a f/#_{T} in the T pop-out lens state, and wherein f/#_{T}<7.0.

45. The lens system of claim 28, wherein the zoom lens has a f/#_{W} in the Wide pop-out lens state, and wherein f/#_{W}<4.0.

46. The lens system of claim 28, wherein the zoom lens has a f/#_{W} in the Wide pop-out lens state, and wherein f/#_{W}<3.0.

47. The lens system of claim 28, wherein the zoom lens has a f/#_{W} in the Wide pop-out lens state, and wherein f/#_{W}<2.5.

48. The lens system of claim 28, wherein the zoom lens has a f/#_{W} in the Wide pop-out lens state, and wherein f/#_{W}<2.25.

49. The lens system of claim 28, included in a pop-out camera that has an actuator, wherein the actuator is operational to move G1, G2 and G3 relative to each other and relative to the image sensor for switching the pop-out camera between the Wide pop-out lens state, the Tele pop-out lens state and the collapsed state.

50. The lens system of claim 49, wherein the actuator is operational to switch the pop-out camera between the W pop-out lens state and the T pop-out lens state in a continuous manner.

51. The lens system of claim 49, wherein the actuator is operational to switch the pop-out camera between the W pop-out lens state and the T pop-out lens state in a discrete manner.

52. The lens system of claim 28, wherein the pop-out camera is included in a mobile device.

53. The lens system of claim 52, wherein the mobile device is a smartphone.
